(19) United States
(12) Patent Application Publication
(10) Pub. No.: US 2017/0147402 A1
(43) Pub. Date: May 25, 2017

(54) OPTIMIZED TASK PARTITIONING THROUGH DATA MINING

(71) Applicant: GM GLOBAL TECHNOLOGY OPERATIONS LLC, DETROIT, MI (US)

(72) Inventors: SHUQING ZENG, STERLING HEIGHTS, MI (US); SHIGE WANG, NORTHVILLE, MI (US); STEPHEN G. LUSKO, WARREN, MI (US)

(21) Appl. No.: 14/951,645

(22) Filed: Nov. 25, 2015

(51) Int. Cl. G06F 9/50

(52) U.S. Cl. CPC G06F 9/505; G06F 9/5016

(57) ABSTRACT

A method of partitioning tasks on a multi-core ECU. A signal list of a link map file is extracted in a memory. Memory access traces relating to executed tasks are obtained from the ECU. A number of times each task accesses a memory location is identified. A correlation graph between the each task and each accessed memory location is generated. The correlation graph identifies a degree of linking relationship between each task and each memory location. The correlation graph is re-ordered so that the respective tasks and associated memory locations having greater degrees of linking relationships are adjacent to one another. The tasks are partitioned into a respective number of cores on the ECU. Allocating tasks and memory locations among the respective number of cores is performed as a function of substantially balancing workloads with minimum cross-core communication among the respective cores.

### BACKGROUND OF INVENTION

An embodiment relates to partitioning a set of tasks on an electronic control unit.

A multi-core processor integrated within a single chip and is typically referred to as a single computing unit having two or more independent processing units commonly referred to as cores. The cores typically carry out read and execute programmed instructions. Examples of such instructions are adding data and moving data. An efficiency of the multi-core processor is that the cores can run multiple instructions at the same time in parallel.

Memory layouts affect the memory bandwidth for cache enabled architecture for an electronic control units (ECU). For example, if a multi-core processor is inefficiently designed, bottlenecks in retrieving data may occur if the tasks among multiple cores are not properly balanced, which also affects communication costs.

### SUMMARY OF INVENTION

An advantage of an embodiment is optimizing access of data in a global memory so that data stored in a respective location and accessed by a respective task in processed by a same respective core. In addition, the workload among the cores is balanced among the respective number of cores of the multi-core processor so that each of the respective cores performs a similar amount of workload processing. The embodiments described herein generated a plurality of permutations based on re-ordering techniques for pairing respective tasks with respective memory locations based on accessing memory locations. Permutations are divided and subdivided based on the number of cores desired until a respective permutation is identified that generates a balanced workload among the cores as well as minimizing communication costs.

An embodiment contemplates a method of partitioning tasks on a multi-core electronic control unit (ECU). A signal list of a link map file is extracted in a memory. The link map file includes a text file that details where data is accessed within a global memory device. Memory access traces relating to executed tasks from the signal list are obtained. A number of times each task accessed a memory location and the respective task workload on the ECU is identified. A correlation graph is generated between each task and each accessed memory location. The correlating graph identifies a degree of linking relationship between each task and each memory location. The correlation graph is reordered so that the respective tasks and associated memory locations having greater degrees of linking relationships are adjacent to one another. The multi-core processor is partitioned into a respective number of cores, wherein allocating tasks and memory locations among the respective number of cores is performed as a function of substantially balancing workloads among the respective cores.

### BRIEF DESCRIPTION OF DRAWINGS

FIG. 1 is a block diagram of hardware used to optimize task partitioning.

FIG. 2 is an exemplary weighted correlation matrix.

FIG. 3 is an exemplary bipartite graph for an initial permutation.

FIG. 4 is an exemplary bipartite graph for a reordered permutation and partitioning.

FIG. 5 is a flowchart of a method for optimizing task partitions.

### DETAILED DESCRIPTION

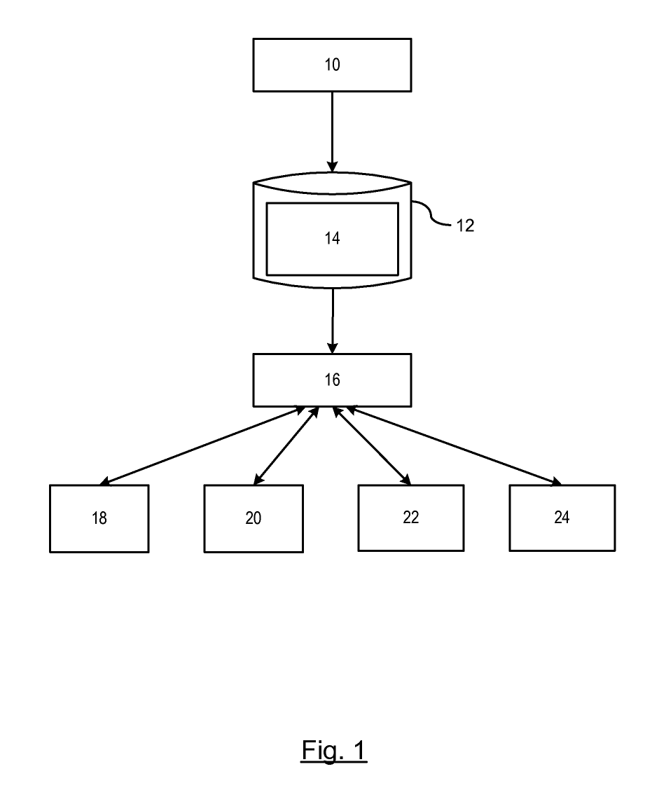

FIG. 1 is a block diagram of hardware used to optimize task partitioning. Respective algorithms executing application codes are executed on an electronic control unit (ECU) 10. The algorithms executed are those programs that would be executed in production (e.g., vehicle engine control, computers, games, factory equipment, or any other electronic controls that utilizes an electronic control unit). Data is written and read to various addresses within a global memory device 12.

A map link file 14 is a text file that details where data and code is stored inside your executables within the global memory device 12. The map link file 14 includes trace files that contain an event log describing what transactions have occurred within the global memory device 12 as to where code and data are stored. As a result, a link file map 14 may be obtained identifying all the tasks and the associated memories addresses that were accessed when the application code was executed by the ECU 10.

A mining processor 16 is used to perform data mining 18 from the global memory device 12, reordering tasks and associated memory locations 20, identifying workloads of a permutation 22, and partitioning tasks and associated memory locations 24 for designing the multi-core processor.

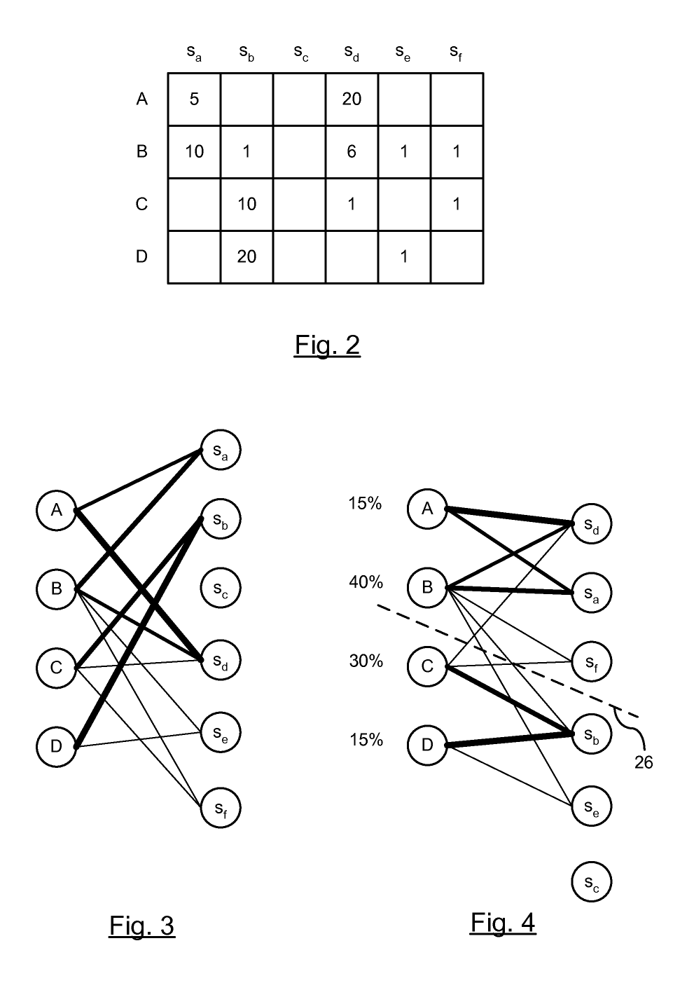

In regards to data mining, for each task (e.g., A, B, C, D) a memory access hit count table is constructed as illustrated in FIG. 2. The term ‘hit count’ refers to the number of times that a respective task transmits a signal to access a respective memory address of the global memory. A matrix X is constructed based on the hit count. As shown in FIG. 2, tasks are listed in the horizontal rows of the matrix and the signals representing accessing of the memory locations of the global memory device are listed in the columns of the matrix. As shown in the matrix, task A accesses sₐ five times and accesses s_{d} twenty times. Task B accesses sₐ ten times, accesses s_{b} one time, accesses s_{d} six times, accesses sₑ one time, and accesses s_{f} one time. The matrix correlates each task with each memory location and identifies the number times the memory location was accessed by the respective task for storing and reading data.

After the matrix X is generated, the mining processor generates permutations that are used to identify the respective permutation that will provide the most efficient partitioning to evenly distribute the workload of the ECU.

Permutations are various listings of ordering tasks and memory locations. As shown in FIG. 3, a correlation graph such as a bipartite graph is constructed. It should be understood that other types of graphs or tools may be used without deviating from the scope of the invention. As shown in FIG. 3, the tasks are listed in a column (e.g., alphabetical order) on the left side of the bipartite graph. On the right side of the bipartite graph, accessed memory locations are listed in a second column. For the purposes of the bipartite graph, the tasks will be referred to task nodes and the accessed memory locations will be referred to as the memory nodes. Lines are drawn connecting a respective task node with a respective memory node when a hit occurs between a respective task node and a respective memory node. The lines connecting the task nodes and memory nodes are weighted as shown in FIG. 3 based on the number of hits. In the bipartite graph, the heavier the weight of the line, the greater the number of hits between the task node and the memory node. In the initial permutation as shown in FIG. 3, lines connecting the task nodes and the memory nodes may be distal meaning that a task node at the top of the first column may be connected to a memory node at the bottom of the second column. If this permutation were partitioned evenly at its midway point of both columns, then a considerable amount of communication would be occurring between the two cores (e.g., cross communication) which would be inefficient and increase communication cost, and more specifically, a greater degree of inefficiency would result if those respective cross communication links between both cores were heavily weighted communication links. In addition, a respective core may carry more of the workload processing if those tasks that are computationally intensive are allocated to a respective core. As a result, various permutations are made by reordering the task nodes and memory nodes.

FIG. 4 illustrates a respective permutation where the memory locations have been re-ordered. Various techniques may be used to reorder the memory nodes to achieve efficiency and minimize communication cost. One such technique may include, but is not limited to, re-ordering the task and memory nodes such that a respective task node and associated memory node having a heavily weighted line (e.g., numerous hits) therebetween, compared to all the other pairs, are adjacent to one another in the bipartite graph.

The reordering of the vertices of the bipartite graph is performed using a weighted adjacent matrix

$$W = [ \begin{matrix}0 & {X}^{T} \\ X & 0\end{matrix} ]$$

constructed using the matrix X in FIG. 2. With matrix W, the desired order of task and memory nodes is achieved through finding a permutation {πᵢ, . . . , π_{N}} of vertices such that adjacent vertices in the graph are the most correlated ones. Such a permutation indicates that the frequent accessed data by the same set of tasks can be fit in a local data cache. Mathematically, the desired reordering permutation can be express as

minJ(π)=Σₗ₌₁^{N-1}l²Σᵢ₌₁^{N-l}w_{π}_{ᵢ}_{,π}_{ᵢ₊ₗ}.

This is equivalent to finding the inverse permutation π⁻¹ such that the following energy function is minimized:

$${min}_{{π}^{- 1}} J ( {π}^{- 1} ) = {\sum }_{a , b} {( {π}_{a}^{- 1} - {π}_{b}^{- 1} )}^{2} {w}_{ab}$$

Solving the above problem is approximated by computing the eigenvector (q₂) with the second smallest eigenvalue for the following eigen equation:

(D−W)q=λDq

where the Laplacian matrix L=D−W, the degree matrix D is a diagonal, and defined as

$${d}_{ij} = \{ \begin{matrix}{\sum }_{i} {w}_{ij} , i = j \\ 0 , Otherwise .\end{matrix}$$

The thus-obtained q₂ is sorted in ascending order. The index of the vertices after sorting is the desired permutation {πᵢ, . . . , π_{N}}. The order of task nodes and memory nodes is then derived from this permutation by rearranging the task nodes and memory nodes in the bipartite graph according to the permutation result.

As illustrated in FIG. 4, the list is efficiently reordered. Task node A and memory node s_{d} is among the highest hits (e.g., 20) and therefore are adjacent to one another. Similarly, it is shown in FIG. 4, task node B is adjacent to memory node sₐ, and task nodes C and D are adjacent to memory node s_{b}. In addition, task node A has numerous hits with memory node sₐ and task node B has numerous hits with memory node s_{d}. As a result, since task nodes A and B are adjacent to one another in the first column, memory nodes sₐ and s_{b} are positioned adjacent to one another in the second column. This re-ordering provides efficient communication by eliminating cross communication between cores.

To even out the workload assure that the workload of the cores are evenly distributed, the first two pairs of task nodes and associated memory nodes having a highest workload among the plurality of task nodes are split and positioned at opposite ends of the bipartite graph. This assures that these two respective task nodes having the highest workload among the plurality of tasks will not be within a same core which would otherwise overload the workload for a single core. After these two pair of tasks are reordered, a next pair of tasks and associated memory nodes having a next highest workload among the remaining task nodes and memory nodes are split and positioned next to the previous split task nodes and memory nodes. This procedure continues with a next respective pair of task nodes and associated memory nodes having a next highest workload among the available task nodes and associated memory nodes until all available task nodes and associated memory nodes are allocated within the bipartite graph. This results in an even distribution of workloads such that the bipartitan graph may be divided equally in the middle as shown and the workload distribution between the respective cores are substantially similar. As shown in the bipartitan graph in FIG. 4, a partition 26 splits the respective task nodes and associated memory nodes of the bipartitan graph to identify which tasks would be allocated to the respective cores. Exemplary workload percentages are illustrated for each respective task node. Task A represents 15% workload usage, task B represents 40% workload usage, task C represents 30% workload usage, and task D represents 15 workload usage. Therefore, in this example, 55% workload usage would be performed by a first core and 45% workload would be performed by the second core. It is noted that the respective heaviest workload of a task node and an associated memory node would remain in a respective core as opposed to cross communication between cores. That is, those task nodes and associated memory nodes having elevated hits would be within the same core. It is understood that some task nodes will cross communicate with memory nodes in different cores; however, such communications will be infrequent compared to the heavily weighted communications maintained within a core.

Moreover, once the two cores have been partitioned, if additional partitioning of cores are required (e.g., 4 core), then the partitioned cores may be subdivided again, without reordering, based on workload balancing and minimizing communication costs. Alternatively, the reordering technique may be applied if desired to an already portioned core to reorder the respective tasks and memories therein and then subdivide the cores further.

Various permutations of partitioning may be applied to find the most efficient partition that produce the most balance workload between the cores of the processor and also minimize communication costs.

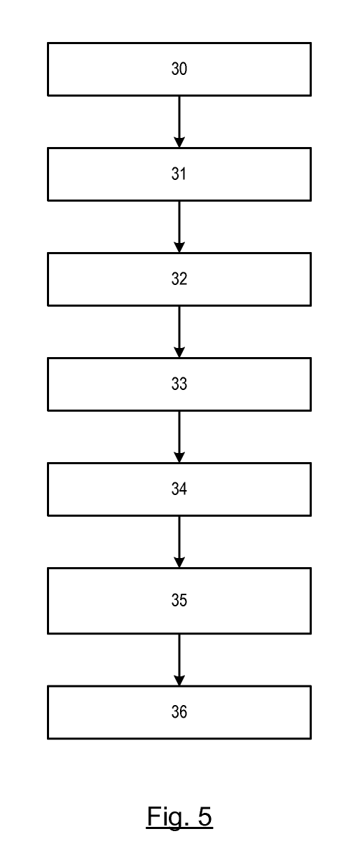

FIG. 5 illustrates a flowchart of the technique for partitioning the tasks running on the multicore ECU. In step 30, application codes for a software program are executed as the tasks by a respective electronic control unit. Both read and write operations are executed in the global memory device (e.g., memory not on the mining processor).

In step 31, a signal list is extracted from a link map file in a global memory. The signal list identifies traces of memory locations hit by the tasks executed by the application codes.

In step 32, the memory access traces are collected by a mining processor.

In step 33, a matrix is constructed that includes the task memory access count (i.e., hits) for each memory location. It should be understood that respective tasks and respective memory locations would not have any hit, and under such circumstances, the entry will be shown as a “0” or left blank indicating that the task did not access the respective location.

In step 34, various permutations are generated that include correlation graphs (e.g., bipartite graphs) that show the linking relationships between the tasks nodes executed by the application code and respective memory nodes accessed by the task nodes. Each of the permutations utilizes optimum ordering algorithms for determining the respective order of the task nodes and associated memory nodes. Task nodes are correlated with those memory nodes having hits between one another and are disposed adjacent to one another. The task nodes and associated memory nodes are optimally positioned in the correlation graph so that when partitioned, workload usages within the cores of the processor are substantially balanced.

In step 35, the correlation is partitioned for identifying which tasks are associated with which core when the tasks are executed on the ECU. The partition will select a split with respect to the respective task nodes and associated memory nodes based on the balance workload and minimized communication costs. Additional partitioning is performed based on the required number of cores in the ECU.

In step 36, the selected permutation is used to design and produce the task partitioning of the multi-core ECU.

While certain embodiments of the present invention have been described in detail, those familiar with the art to which this invention relates will recognize various alternative designs and embodiments for practicing the invention as defined by the following claims.

What is claimed is:

1. A method of partitioning tasks on a multi-core electronic control unit (ECU) comprising the steps of:
extracting a signal list of a link map file in a memory, the link map file including a text file that details where data is accessed within a global memory device;
obtaining memory access traces relating to executed tasks from the signal list;
identifying a number of times each task accessed a memory location and the respective task workload on the ECU;
generating a correlation graph between each task and each accessed memory location, the correlating graph identifying a degree of linking relationship between each task and each memory location;
reordering the correlation graph so that the respective tasks and associated memory locations having greater degrees of linking relationships are adjacent to one another;
partitioning the multi-core processor into a respective number of cores, wherein allocating tasks and memory locations among the respective number of cores is performed as a function of substantially balancing workloads among the respective cores.

2. The method of claim 1 wherein the tasks on multi-core ECU are partitioned for two cores.

3. The method of claim 1 wherein the tasks on multi-core ECU are partitioned for four cores.

4. The method of claim 1 wherein the tasks on multi-core ECU are partitioned for an even number of cores.

5. The method of claim 1 wherein the tasks on multi-core ECU are partitioned for the number of cores by balancing the workload among the number of cores in a single partitioning.

6. The method of claim 1 wherein the tasks are initially split into an initial pair of cores based on a balanced workload, and wherein the initial pair of cores are repeatedly split based on a balanced workload until a desired number of cores are obtained.

7. The method of claim 1 wherein a weighted matrix is generated that identifies the number of times each task accessed a memory location.

8. The method of claim 7 wherein the correlation graph includes a bipartite graph, wherein the bipartite graph is generated as a function of the weighted matrix.

9. The method of claim 8 wherein reordering is based on an identified workload of each task, wherein the respective task in a first column of the bipartite graph is positioned adjacent to the respective memory location in a second column of the bipartite graph based on the respective task accessing the respective memory location.

10. The method of claim 9 wherein a priority of selecting which memory location from a plurality of memory locations having linking relationships to the respective task to position adjacent to the respective task is determined based on a number of times the respective task accessed the each of the memory locations, wherein the respective memory location being access the most by the respective task is positioned adjacent to the respective task.

11. The method of claim 9 wherein reordering is based on identified workload of each task, wherein a pair of tasks having a highest workload among the plurality of task are split and positioned at opposite ends of the bipartite graph, wherein a next pair of tasks having a next highest workloads among the available tasks are split and positioned next in order to the pair of tasks having the highest workload, and wherein a next respective pair of tasks having a next highest workload among the available tasks are split and position next in order to the previously positioned tasks until each of the available tasks are allocated within the bipartite graph.

12. The method of claim 8 wherein lines connecting a respective task with a respective memory location include weighted lines, wherein the weighting associated with each line identifies a number of number of times the respective task accessed the respective memory location.

13. The method of claim 1 wherein a plurality of permutations are generated reordering the correlation graph, wherein a respective permutation providing the most balanced workload among the plurality of permutations is selected for partitioning.

14. The method of claim 13 wherein selecting the respective permutation is further determined as a function of which permutation provides a minimum communication cost.

15. The method of claim 1 further comprising the steps of executing application codes on an electronic control unit, the link map file is generated as a result of accessing memory locations based on execution of the application codes.

16. The method of claim 1 wherein a degree of linking relationship between a respective task and a respective memory location is determined as a function of a number of times a respective task accessed the respective memory location.
